(19) United States
(12) Patent Application Publication
(10) Pub. No.: US 2025/0335348 A1
(43) Pub. Date: Oct. 30, 2025

(54) METHOD, DEVICE, SYSTEM, AND COMPUTER PROGRAM FOR PROCESSING-IN-MEMORY COMPUTATION OFFLOADING FOR IMPROVING INFERENCE PERFORMANCE OF ARTIFICIAL INTELLIGENCE MODEL

(71) Applicant: SAMSUNG SDS CO., LTD., Seoul (KR)

(72) Inventors: Jieun CHOI, Seoul (KR); Hyojung LEE, Seoul (KR); Jimyoung SON, Seoul (KR)

(73) Assignee: SAMSUNG SDS CO., LTD., Seoul (KR)

(21) Appl. No.: 19/173,205

(22) Filed: Apr. 8, 2025

(30) Foreign Application Priority Data
Apr. 25, 2024 (KR) 10-2024-0055199
Oct. 28, 2024 (KR) 10-2024-0148953

(51) Int. Cl. G06F 12/02

(52) U.S. Cl. CPC G06F 12/0223

(57) ABSTRACT

The present disclosure relates to a method, a device, a system, and a computer program for processing-in-memory computation offloading for improving the inference performance of an artificial intelligence model. More specifically, the present disclosure provides a method for performing processing-in-memory (PIM) offloading by using a computing device, the method including: collecting information about a first computation to be processed, the first computation including an operator and at least one operand; determining the usefulness of offloading the first computation, based on the information about the first computation and the optimal operand size of a processing-in-memory (PIM); and offloading the first computation, based on the determination.

### CROSS-REFERENCE TO RELATED APPLICATION(S)

This application is based on and claims priority under 35 U.S.C. 119 to Korean Patent Application No. 10-2024-0055199, filed on Apr. 25, 2024 and Korean Patent Application No. 10-2024-0148953, filed on Oct. 28, 2024, in the Korean Intellectual Property Office, the disclosure of which is herein incorporated by reference in its entirety.

### BACKGROUND OF THE INVENTION

### 1. Field of the Invention

The present disclosure relates to a method, a device, a system, and a computer program for processing-in-memory computation offloading for improving the inference performance of an artificial intelligence model and, more specifically, to a method, a device, a system, and a computer program for processing-in-memory computation offloading for improving the inference performance of an artificial intelligence model that can selectively perform offloading by determining the usefulness of processing-in-memory offloading for a computation to be performed.

### 2. Description of the Prior Art

Recently, artificial intelligence models such as large language models (LLMs) have been continuously developing, and various technologies and services based on these models are rapidly increasing.

As a result, various studies are being conducted to improve the inference speed of artificial intelligence models, and more specifically, software-based techniques such as scheduling for inference requests and memory paging of KV caches for memory management are being attempted. However, with the rapid increase in demand for related services, efficiently processing inference requests has become challenging.

Recently, processing-in-memory (PIM) technology, which performs computations in a memory separately from computation processing using typical computation devices such as CPUs or GPUs, has been developed. However, PIM technology is still in an early stage and is only used for simple linear algebra computations.

As a result, technologies optimized for specific applications, such as a technology for improving inference performance by reflecting the characteristics of artificial intelligence models, are not provided. Furthermore, depending on the type of computation performed in an artificial intelligence model, the advantages and disadvantages of processing-in-memory (PIM) may vary, and the inference performance of the artificial intelligence model may also vary. However, appropriate methods for scheduling processing-in-memory (PIM) offloading in consideration of this have not yet been proposed.

### SUMMARY OF THE INVENTION

The present disclosure has been made to solve the above-described problems of the prior art. An aspect of the present disclosure is to provide a method, a device, a system, and a computer program for processing-in-memory computation offloading for improving the inference performance of an artificial intelligence model, wherein the inference performance of the artificial intelligence model can be improved based on the computational capability of a processing-in-memory (PIM) based on hardware in addition to conventional software-based techniques for improving the inference performance of the artificial intelligence model.

More specifically, an aspect of the present disclosure is to provide a method, a device, a system, and a computer program for processing-in-memory computation offloading for improving the inference performance of an artificial intelligence model, wherein the inference performance of the artificial intelligence model can be efficiently improved by determining the usefulness of processing-in-memory (PIM) offloading for various types of computations performed in the artificial intelligence model.

The technical problems to be solved in the present disclosure are not limited to the technical problems mentioned above, and other technical problems not mentioned will be clearly understood by those skilled in the art to which the present disclosure belongs from the description of this specification.

According to a first aspect of the present disclosure, a method for performing processing-in-memory (PIM) offloading by using a computing device may include: collecting information about a first computation to be processed, the first computation including an operator and at least one operand; determining usefulness of offloading the first computation, based on the information about the first computation and an optimal operand size of a processing-in-memory (PIM); and offloading the first computation, based on the determination.

In the determining operation, the usefulness of offloading the first computation may be determined based on a type of operator in the first computation, a size of the at least one operand in the first computation, and the optimal operand size of the processing-in-memory (PIM).

Furthermore, the method may further include determining whether in an artificial intelligence model, the first computation corresponds to an initial phase, in which an initial token for an input is generated, or a generation phase, in which a subsequent token is generated, and determining not to offload the first computation in case that the first computation corresponds to the initial phase. Furthermore, the method may further include determining whether the type of the operator in the first computation corresponds to a GEMV or GEMM computation, and determining not to offload the first computation in case that the type of the operator does not correspond to the GEMV or GEMM computation.

Furthermore, in the determining operation, the usefulness of offloading the first computation may be calculated based on: an offloading benefit resulting from offloading the first computation to the processing-in-memory (PIM) and processing the first computation; and an offloading overhead required for offloading the first computation to the processing-in-memory (PIM) and processing the first computation.

The offloading benefit of the first computation may be calculated based on: a computation time required for offloading the first computation to the processing-in-memory (PIM) and performing the first computation; and a computation time required for performing the first computation without offloading the first computation.

Furthermore, the offloading overhead of the first computation may be calculated based on: a resource required for offloading the first computation to the processing-in-memory (PIM) and processing the first computation in an all-bank mode; and a resource required for performing the first computation without offloading the first computation.

Furthermore, the offloading overhead of the first computation may be calculated based on a resource required for converting the first computation in accordance with a data format of the processing-in-memory (PIM) in order to offload the first computation to the processing-in-memory (PIM).

Furthermore, the offloading overhead of the first computation may be calculated based on a resource required for returning a result of processing the first computation that has been offloaded to the processing-in-memory (PIM).

Furthermore, according to a second aspect of the present disclosure, a device for performing processing-in-memory (PIM) offloading may include: a processor; and a memory, wherein the memory includes instructions configured to, when executed by the processor, cause the device to implement specific operations, and the specific operations includes: collecting information about a first computation to be processed, the first computation including an operator and at least one operand; determining usefulness of offloading the first computation, based on the information about the first computation and an optimal operand size of a processing-in-memory (PIM); and offloading the first computation, based on the determination.

In the determining operation, the usefulness of offloading the first computation may be determined based on a type of operator in the first computation, a size of the at least one operand in the first computation, and the optimal operand size of the processing-in-memory (PIM).

Furthermore, the specific operations may further include determining whether in an artificial intelligence model, the first computation corresponds to an initial phase, in which an initial token for an input is generated, or a generation phase, in which a subsequent token is generated, and determining not to offload the first computation in case that the first computation corresponds to the initial phase.

The specific operations may further include determining whether the type of the operator in the first computation corresponds to a GEMV or GEMM computation, and determining not to offload the first computation in case that the type of the operator does not correspond to the GEMV or GEMM computation.

Furthermore, in the determining operation, the usefulness of offloading the first computation may be calculated based on: an offloading benefit resulting from offloading the first computation to the processing-in-memory (PIM) and processing the first computation; and an offloading overhead required for offloading the first computation to the processing-in-memory (PIM) and processing the first computation.

The offloading benefit of the first computation may be calculated based on: a computation time required for offloading the first computation to the processing-in-memory (PIM) and performing the first computation; and a computation time required for performing the first computation without offloading the first computation.

Furthermore, the offloading overhead of the first computation may be calculated based on: a resource required for offloading the first computation to the processing-in-memory (PIM) and processing the first computation in an all-bank mode; and a resource required for performing the first computation without offloading the first computation.

Furthermore, the offloading overhead of the first computation may be calculated based on a resource required for converting the first computation in accordance with a data format of the processing-in-memory (PIM) in order to offload the first computation to the processing-in-memory (PIM).

Furthermore, the offloading overhead of the first computation may be calculated based on a resource required for returning a result of processing the first computation that has been offloaded to the processing-in-memory (PIM).

Furthermore, according to a third aspect of the present disclosure, in a computer-readable storage medium storing instructions configured to, when executed by a processor, cause a device, including the processor and configured to perform processing-in-memory (PIM) offloading, to implement specific operations, the specific operations may include: collecting information about a first computation to be processed, the first computation including an operator and at least one operand; determining usefulness of offloading the first computation, based on the information about the first computation and an optimal operand size of a processing-in-memory (PIM); and offloading the first computation, based on the determination.

Here, in the determining operation, the usefulness of offloading the first computation may be determined based on a type of operator in the first computation, a size of the at least one operand in the first computation, and the optimal operand size of the processing-in-memory (PIM).

Accordingly, in the method, the device, the system, and the computer program for processing-in-memory computation offloading for improving the inference performance of an artificial intelligence model according to one embodiment of the present disclosure, the inference performance of the artificial intelligence model may be improved based on the computational capability of a processing-in-memory (PIM) based on hardware in addition to the conventional software-based techniques for improving the inference performance of the artificial intelligence model.

More specifically, in the method, the device, the system, and the computer program for processing-in-memory computation offloading for improving the inference performance of an artificial intelligence model according to one embodiment of the present disclosure, the inference performance of an artificial intelligence model may be efficiently improved by determining the usefulness of processing-in-memory (PIM) offloading with respect to various types of computations performed in the artificial intelligence model.

The effects that may be obtained from the present disclosure are not limited to the effects mentioned above, and other effects not mentioned will be clearly understood by those skilled in the art to which the present disclosure belongs from the description of this specification.

### BRIEF DESCRIPTION OF THE DRAWINGS

The accompanying drawings, which are included as part of the detailed description in order to help understand the present disclosure, provide an embodiment of the present disclosure and illustrate the technical idea of the present disclosure along with the detailed description.

FIG. 1 illustrates the configuration of a PIM offloading system according to one embodiment of the present disclosure;

FIG. 2 is a flowchart illustrating a PIM offloading method according to one embodiment of the present disclosure;

FIG. 3 is a block diagram of a PIM offloading device according to one embodiment of the present disclosure;

FIGS. 4 to 6 illustrate specific operations of a PIM offloading device according to one embodiment of the present disclosure;

FIGS. 7 to 12 illustrate specific embodiments according to various operation environments of a PIM offloading device according to one embodiment of the present disclosure;

FIG. 13 is a flowchart illustrating specific operations of a PIM offloading device according to one embodiment of the present disclosure; and

FIG. 14 illustrates the configuration of a computing device for performing PIM offloading according to one embodiment of the present disclosure.

### DETAILED DESCRIPTION OF THE EXEMPLARY EMBODIMENTS

Hereinafter, the embodiments disclosed in the present specification will be described in detail with reference to the accompanying drawings. The aspects, specific advantages, and novel features of the present disclosure will become apparent from the following detailed description and preferred embodiments associated with the accompanying drawings.

The terms and words used in the present specification and in the claims are defined appropriately by the inventor to best describe the disclosure and should be construed as meanings or concepts consistent with the technical idea of the present disclosure. The terms and words are merely provided to describe embodiments and should not be construed as limiting the present disclosure.

In assigning reference numerals to components, identical or similar components are assigned the same reference numerals regardless of the reference numerals, and redundant descriptions thereof will be omitted. The suffixes “module” and “unit” for components, used in the following description, are given or used interchangeably for ease of drafting the specification, do not inherently have distinct meanings or roles, and may refer to either software or hardware components.

In describing the components of the present disclosure, when a component is expressed in the singular form, it is to be understood that the component also includes the plural form unless otherwise specifically stated. Furthermore, the terms “first,” “second,” and the like are used to distinguish one component from another, and the components are not limited by the terms. Furthermore, when a component is connected to another component, it is intended that another component may be connected between the component and the other component.

Furthermore, in describing embodiments disclosed in the present specification, detailed descriptions of related well-known technologies may be omitted when the detailed descriptions are considered to obscure the essence of the embodiments disclosed in the present specification. Furthermore, the accompanying drawings are provided only to facilitate understanding of the embodiments disclosed in the present specification, and it is to be understood that the technical idea disclosed in the present specification is not limited by the accompanying drawings and include all modifications, equivalents, or substitutions that are within the scope of the idea and technology of the present disclosure.

Hereinafter, exemplary embodiments of a method, a device, a system, and a computer program for processing-in-memory computation offloading for improving the inference performance of an artificial intelligence model, according to one embodiment of the present disclosure, will be described in detail with reference to the accompanying drawings.

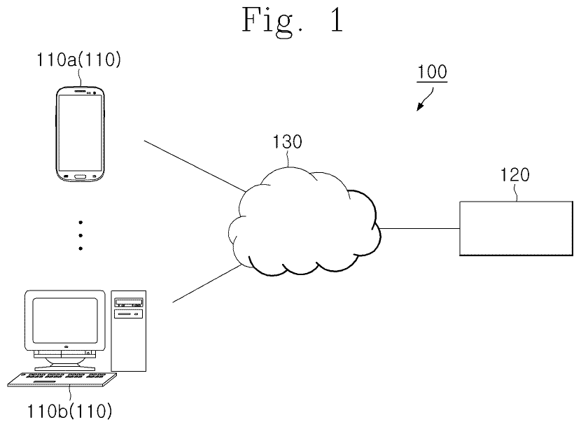

FIG. 1 illustrates the configuration and operation of a PIM offloading system 100 according to one embodiment of the present disclosure. As illustrated in FIG. 1, the PIM offloading system 100 according to one embodiment of the present disclosure may include at least one user terminal 110 and a PIM offloading device 120 configured to offload computations to a processing-in-memory (PIM).

A user can use each terminal 110a or 110b to provide a configuration or information necessary for PIM offloading, and furthermore, the user can receive data resulting from the PIM offloading.

As the terminal 110, various terminals, such as a personal computer (PC), a notebook PC, a tablet PC, a smartphone, or PDA, which can provide a configuration or information for PIM offloading or receive data resulting from the PIM offloading, may be used. However, the present disclosure is not necessarily limited thereto. Various devices, such as server, which can provide information necessary for PIM offloading may also be used as the terminal 110.

Furthermore, the PIM offloading device 120 may be implemented using at least one physical server device, but the present disclosure is not necessarily limited thereto. The PIM offloading device 120 may also be configured using a personal computing device such as a desktop computer, a laptop, a tablet, or a smartphone, or implemented in various forms such as dedicated devices.

Furthermore, it is also possible to implement the terminal 110 and the PIM offloading device 120 as a single device.

Furthermore, as a communication network 130 configured to connect the terminal 110 to the PIM offloading device 120 in FIG. 1, a wired network and a wireless network may be used, and specifically, the communication network 130 may include various communication networks such as a local area network (LAN), a metropolitan area network (MAN), and a wide area network (WAN). Furthermore, the communication network 130 may include the well-known World Wide Web (WWW). Furthermore, the communication network 130 may be implemented using a data bus, etc. that is configured to transmit and receive data, etc.

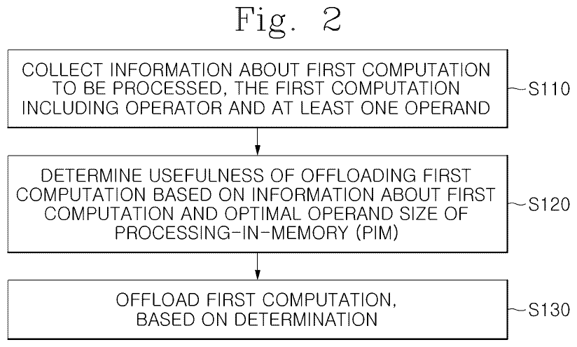

FIG. 2 illustrates a flowchart of a PIM offloading method according to one embodiment of the present disclosure.

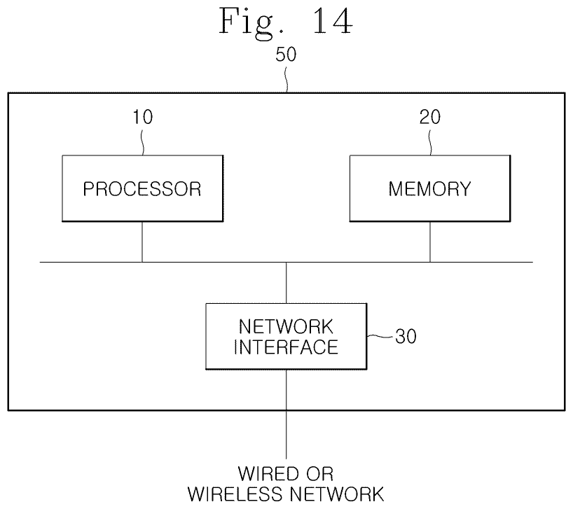

The method illustrated in FIG. 2 may be performed, for example, by the PIM offloading device 120, and furthermore, the PIM offloading device 120 may be implemented as including a computing device 50 in FIG. 14 and the description made later with reference to FIG. 14. For example, the PIM offloading device 120 may include a processor 10 and the processor 10 may execute instructions configured to implement operations for offloading computations to PIM.

More specifically, as illustrated in FIG. 2, the PIM offloading method according to one embodiment of the present disclosure is a method of performing processing-in-memory (PIM) offloading by using the computing device 50, and may include: an operation S110 of collecting information about a first computation to be processed, the first computation including an operator and at least one operand; an operation S120 of determining the usefulness of offloading the first computation, based on the information about the first computation and an optimal operand size of the processing-in-memory (PIM); and an operation S130 of offloading the first computation, based on the determination.

In the determining operation S120, the usefulness of offloading the first computation may be determined based on the type of operator in the first computation, the size of the at least one operand in the first computation, and the optimal operand size of the processing-in-memory (PIM).

Furthermore, the method may further include an operation (not shown) of determining whether in an artificial intelligence model, the first computation corresponds to an initial phase, in which an initial token for an input is generated, or a generation phase, in which a subsequent token is generated, and determining not to offload the first computation in case that the first computation corresponds to the initial phase.

Furthermore, the method may further include an operation (not shown) of determining whether the type of the operator in the first computation corresponds to a GEMV or GEMM computation, and determining not to offload the first computation when the type of the operator does not correspond to the GEMV or GEMM computation.

Furthermore, in the determining operation S120, the usefulness of offloading the first computation may be calculated based on: an offloading benefit resulting from offloading the first computation to the processing-in-memory (PIM) and processing the first computation; and an offloading overhead required for offloading the first computation to the processing-in-memory (PIM) and processing the first computation.

The offloading benefit of the first computation may be calculated based on: a computation time required for offloading the first computation to the processing-in-memory (PIM) and performing the first computation; and a computation time required for performing the first computation without offloading the first computation.

Furthermore, the offloading overhead of the first computation may be calculated based on: a resource required for offloading the first computation to the processing-in-memory (PIM) and processing the first computation in an all-bank mode; and a resource required for performing the first computation without offloading the first computation.

Furthermore, the offloading overhead of the first computation may be calculated based on a resource required for converting the first computation in accordance with a data format of the processing-in-memory (PIM) in order to offload the first computation to the processing-in-memory (PIM).

Furthermore, the offloading overhead of the first computation may be calculated based on a resource required for returning the result of processing the first computation that has been offloaded to the processing-in-memory (PIM).

Accordingly, in the method, the device, the system, and the computer program for processing-in-memory computation offloading for improving the inference performance of an artificial intelligence model according to one embodiment of the present disclosure, the inference performance of the artificial intelligence model may be improved based on the computational capability of the processing-in-memory (PIM) based on hardware in addition to the conventional software-based techniques for improving the inference performance of the artificial intelligence model. More specifically, the inference performance of an artificial intelligence model may be efficiently improved by determining the usefulness of processing-in-memory (PIM) offloading with respect to various types of computations performed in an artificial intelligence model.

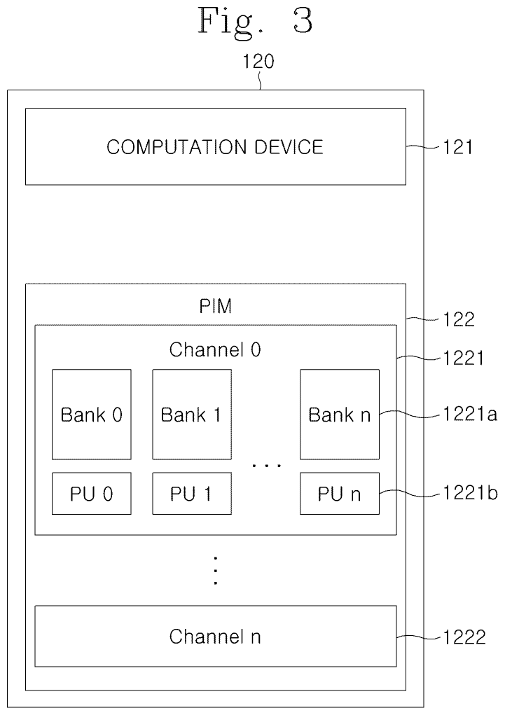

In this regard, FIG. 3 illustrates a block diagram of a PIM offloading device 120 according to one embodiment of the present disclosure.

As illustrated in FIG. 3, the PIM offloading device 120 may include: a computation device 121, which includes a central processing unit (CPU) or a graphics processing unit (GPU) capable of processing a given operation to perform inference in an artificial intelligence model; and a processing-in-memory (PIM) 122.

The PIM 122 may be provided with one or more channels 1221 and 1222. Each channel 1221 may include at least one banks 1221a and at least one processing unit (PU) 1221b, thereby enabling the PIM 122 to perform not only a data storage function but also data computation. In particular, the PIM 122 can perform computations on its own without moving data to the computation device 121, thereby efficiently improving bottlenecks caused by memory bandwidth, etc.

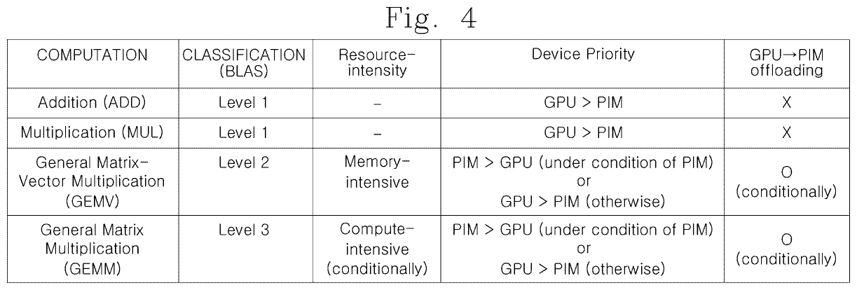

Accordingly, according to one embodiment of the present disclosure, in order to accelerate the inference of an artificial intelligence model, the PIM offloading device 120 may perform scheduling by using the processing unit (PU) 1221b of the PIM 122 along with the GPU of the computation device 121. Computation that can be offloaded to the processing unit 1221b of the PIM 122, i.e., computation that can be processed by the PIM 122, is exemplified in FIG. 4.

In other words, the PIM 122 is a device configured by embedding the processing unit (PU) 1221b for performing computation in a memory such as DRAM. Due to physical limitations, the PIM 122 is unable to perform complex computations, and can only perform computations for operators such as ADD, MUL, GEMV, and GEMM, as illustrated in FIG. 4.

As illustrated in FIG. 4, since ADD and MUL are simple computations corresponding to Basic Linear Algebra Subprograms (BLAS) level 1, it is relatively more advantageous to perform the ADD and MUL computations directly on the computation device 121 rather than offloading the ADD and MUL computations to the PIM 122. The reason for this is that in the case of simple computations such as ADD and MUL, the overhead of offloading, such as the preparation process for performing computations using the PIM 122 (e.g., activation of the PIM 122 and data movement between the PIM 122 and the computation device 121), may be greater than the benefit of offloading.

Accordingly, in the PIM offloading device 120 according to one embodiment of the present disclosure, offloading of two computations (ADD and MUL) corresponding to BLAS level-1 to the PIM 122 may be prevented.

On the other hand, in the PIM offloading device 120 according to one embodiment of the present disclosure, offloading GEMV and GEMM computations to the PIM 122 depending on the operation environment may be advantageous for accelerating the inference of an artificial intelligence model.

More specifically, referring to FIG. 4, a GEMV operator may be classified as a memory-intensive operator because memory access for computation may occur more frequently than the computation. Therefore, offloading the computation to the PIM 122 and performing the computation may be more efficient than performing the computation in the computation device 121.

However, in the PIM offloading device 120 according to one embodiment of the present disclosure, the GEMV computation does not have to be offloaded to the PIM 122 and processed. Rather, the GEMV computation is offloaded to the PIM 122 and processed when certain conditions are met, thereby enabling a more efficient improvement in the inference performance of the artificial intelligence model.

More specifically, when the PIM 122 operates in a single-bank mode, access to individual banks is possible, like general memory. However, when computation is processed using an all-bank mode, only the same logic can be performed in the processing units (PUs) 1221b of all banks. Therefore, if the size of a matrix, which is an operand to be processed by the GEMV operator during the inference of an artificial intelligence model, is small, and thus the memory bank area of the PIM 122 is not fully used, the efficiency of resource use may decrease.

Accordingly, there may be a trade-off between the efficiency of memory resource usage and the ease of memory access, depending on the size of a matrix which is an operand. In this regard, when a matrix having a size suitable for a driving environment such as hardware of the PIM 122, is computed, the gap in the trade-off may be reduced, and thus when the computation is offloaded to the PIM 122 and processed, efficiency may be improved in terms of both performance and resource usage. Therefore, the PIM offloading device 120 according to one embodiment of the present disclosure may determine whether to offload the computation to the PIM 122, in consideration of these conditions.

Furthermore, referring to FIG. 4, in the case of the GEMM operator, memory access may be frequent and the amount of computation may be relatively large. However, the GPU of the computation device 121 can process computations in parallel, so the GEMM operator may be generally classified as a compute-intensive operator, and performing computation in the computation device 121 may be considered to be advantageous. However, when one (typically an input matrix, matrix2) of two matrices (matrix1*matrix2), which are operands, is long and narrow, the matrix may be classified as a memory-intensive operator for the same reasons given to the GEMV operator. Accordingly, in one embodiment of the present disclosure, the PIM offloading device 120 may determine to offload the computation to the PIM 122 under certain conditions.

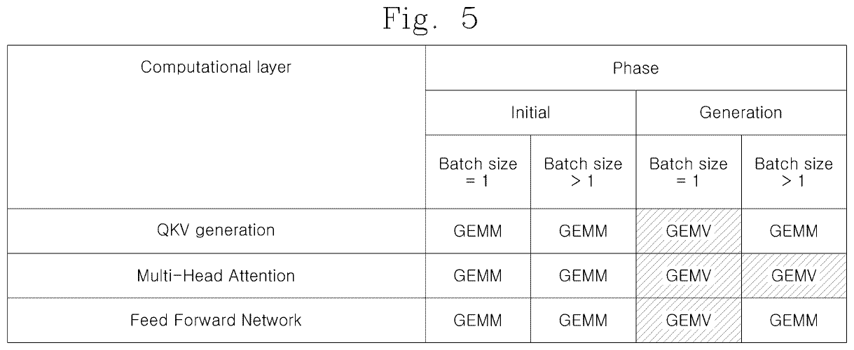

As a more specific example, FIG. 5 illustrates operators (GEMV, GEMM) that can be offloaded to the PIM 122 in a computational layer of a decoder block in a transformer model.

Hereinafter, PIM offloading for improving inference performance in the transformer model is described as one embodiment of the present disclosure, but the present disclosure is not necessarily limited thereto.

As described above, simple operators corresponding to BLAS level 1, such as ADD and MUL, may be excluded from offloading.

Furthermore, referring to FIG. 5, in the case of a QKV generation layer and a feed forward network layer, a GEMV computation may be performed in a generation phase when the batch size is 1. In the case of a multi-head attention layer, a GEMV computation may be performed in the generation phase regardless of the batch size, and thus may be considered to be a candidate operator that is to be offloaded to the PIM 122.

Furthermore, referring to FIG. 5, in the QKV generation layer and the feed forward network layer, offloading to the PIM 122 may be determined in consideration of the size of the batch size. This is because as the batch size becomes smaller, an input matrix has a long and narrow shape (i.e., a shape close to a vector of M×1) and may be advantageous for being offloaded to the PIM 122.

Furthermore, the PIM offloading device 120 according to one embodiment of the present disclosure may not consider offloading, to the PIM 122, a computation corresponding to an initial phase in which an initial token for an input is generated, but may consider offloading, to the PIM 122, only a computation corresponding to the generation phase in which a subsequent token is generated. However, the present disclosure is not necessarily limited thereto.

More specifically, referring to FIG. 5, a GEMM computation may be included in the initial phase. This is because the process of determining whether to offload a computation for generating an initial token may itself be excessive overhead.

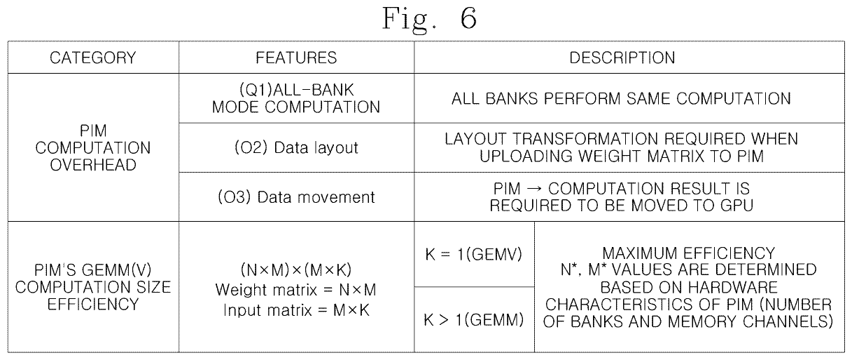

Furthermore, FIG. 6 illustrates overhead due to offloading according to the characteristics of the PIM 122 and efficiency according to the size of operands of the GEMV and GEMM computations in the PIM 122.

More specifically, referring to FIG. 6, the overhead due to offloading to the PIM 122 may include: a first overhead O1 due to an all-bank mode, in which all banks must perform the same computation; a second overhead O2 required for converting the layout of a matrix into a format, which can be computed by the processing unit (PU) 1221b of the PIM 122, for offloading to the PIM 122, and recording the matrix to the bank 1221a of the PIM 122; and a third overhead O3 required for data movement to return the result of computation processed in the PIM 122 to the computation device 121.

Furthermore, referring to FIG. 6, in the case of the PIM 122, the optimal operand size (=N*×M*) of a matrix, which allows computation to be performed with the optimal resource usage efficiency, may be determined based on the number of banks 1221a and channels 1221 of the memory.

Accordingly, in the PIM 122, when the size (=N×M) of a matrix as an operand matches the optimal operand size (=N*×M*), computation may be performed with optimal resource efficiency. However, when the size (=N×M) of the matrix deviates from the optimal operand size (=N*×M*), the resource efficiency of the computation in the PIM 122 may correspondingly decrease.

Furthermore, referring to FIG. 6, when K=1, this may correspond to a GEMV computation, and when K>1, this may correspond to a GEMM computation, wherein as K increases, the size of an input matrix increases, and the resource usage efficiency of the PIM 122 may decrease.

Hereinafter, the configuration and operation of a method, a device, and a system for processing-in-memory computation offloading for improving the inference performance of an artificial intelligence model according to one embodiment of the present disclosure will be described in more detail with reference to the drawings.

First, in operation S110, the computing device 50, such as the PIM offloading device 120 may collect information about a first computation to be processed, and the first computation may include an operator and at least one operand.

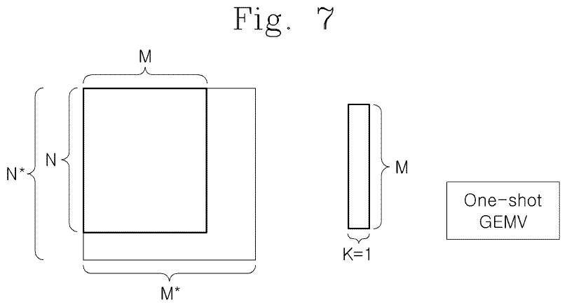

As a more specific example, FIG. 7 illustrates the case in which a GEMV computation is performed using a matrix of size (N×M) and a vector of size (M×1) as operands (where N≤N* and M≤M*).

Accordingly, the first computation may include a GEMV operator as an operator and the matrix of size (N×M) and the vector of size (M×1) as operands, and in operation S110, information about the operator and information about the operands in the first computation may be collected.

In this regard, in operation S120, the usefulness of offloading the first computation may be determined based on information about the first computation and an optimal operand size of the processing-in-memory (PIM).

More specifically, in operation S120, the usefulness of offloading the first computation may be determined based on the type of operator in the first computation, the size of at least one operand in the first computation, and the optimal operand size of the processing-in-memory (PIM).

Furthermore, in operation S120, the usefulness of offloading the first computation may be calculated based on: an offloading benefit of offloading the first computation to the processing-in-memory (PIM) and processing the first computation; and offloading overhead required for offloading the first computation to the processing-in-memory (PIM) and processing the first computation.

The offloading gain of the first computation may be calculated based on: a computation time required for offloading the first computation to the processing-in-memory (PIM) and performing the first computation; and a computation time required for performing the first computation without offloading the first computation.

Furthermore, the offloading overhead O1 of the first computation may be calculated based on: a resource required for offloading the first computation to the processing-in-memory (PIM) and processing the first computation in an all-bank mode; and a resource required for performing the first computation without offloading the first computation.

Furthermore, the offloading overhead O2 of the first computation may be calculated based on a resource required for converting the first computation to a data format of the processing-in-memory (PIM) in order to offload the first computation to the processing-in-memory (PIM).

Furthermore, the offloading overhead O3 of the first computation may be calculated based on a resource required for returning the result of processing the first computation that has been offloaded to the processing-in-memory (PIM).

In this regard, Equation 1 below shows a mathematical expression for calculating the usefulness u(N, M) of offloading when performing a GEMV computation by using the matrix of size (N×M) and the vector of size (M×1) as operands, as illustrated in FIG. 7 (where N≤N* and M≤M*).

$$u ( N , M ) {=}^{def} ( α - γ ) NM - β ( {N}^{*} {M}^{*} - NM ) - ω N \qquad [ Equation 1 ]$$

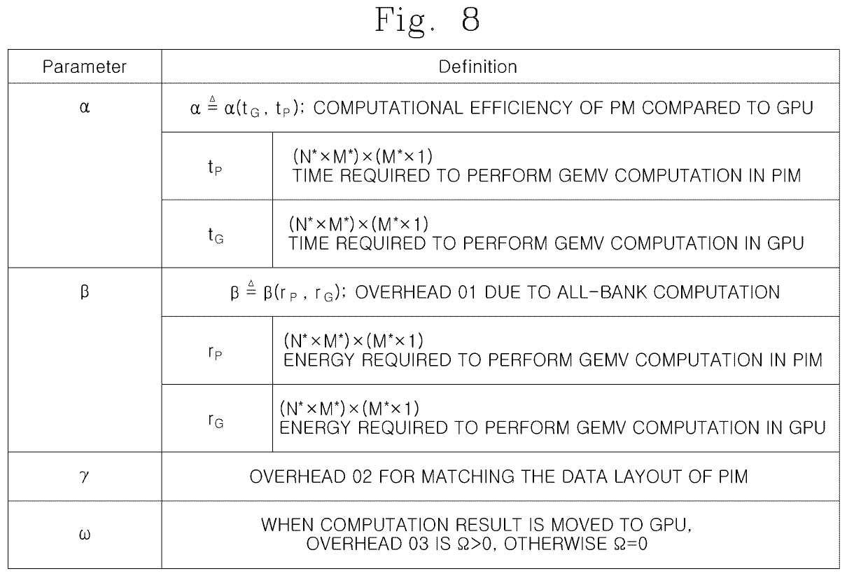

In this regard, FIG. 8 illustrates parameters α, β, γ, and ω of Equation 1.

Referring to FIG. 8, α is a parameter for the computational efficiency of offloading the first computation to the PIM 122 and processing the first computation compared to processing the first computation by using the GPU of the computation device 121. α may be calculated based on a computation time t_{P} required when the first computation is offloaded to the PIM 122 and performed, and a computation time t_{G} required when the first computation is performed on the GPU of the computation device 121 without being offloaded.

Furthermore, referring to FIG. 8, β is a parameter for the first overhead O1 in an all-bank mode in which all banks must perform the same computation. β may be calculated based on: a resource r_{P} required when the first computation is offloaded to the processing-in-memory (PIM) and processed in the all-bank mode; and a resource r_{G} required when the first computation is performed without being offloaded.

Furthermore, referring to FIG. 8, γ is a parameter for the second overhead O2 required for converting the layout of a matrix into a format, which can be computed by the processing unit (PU) 1221b of the PIM 122, for offloading to the PIM 122.

Furthermore, referring to FIG. 8, ω is a parameter for the third overhead O3 required for data movement to return the result of the computation processed in the PIM 122 to the computation device 121.

As described above, for the case of FIG. 7, in operation S120, the usefulness u(N, M) of offloading the first computation may be calculated using Equation 1, based on: the offloading benefit of offloading the first computation, calculated based on the parameter α, to the PIM 122 and processing the first computation; and the offloading overheads O1, O2, and O3 required for offloading the first computation, calculated based on the parameters β, γ, and ω, to the PIM 122 and processing the first computation. However, Equation 1 is merely an embodiment of the present disclosure, and the present disclosure is not necessarily limited thereto.

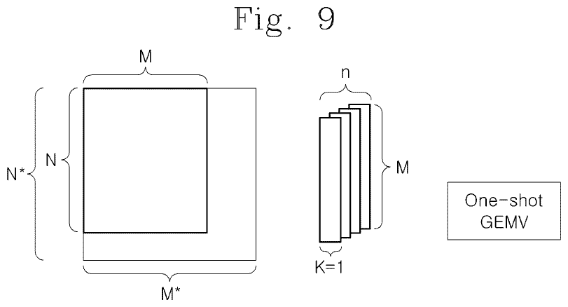

Furthermore, FIG. 9 illustrates an example of repeatedly performing a GEMV computation while changing only input data with respect to the same weights by using a matrix of size (N×M) and a vector of size (M×1) as operands (where N≤N* and M≤M*).

In this regard, Equation 2 below shows a mathematical expression for calculating the usefulness u(N, M) of offloading in the case of FIG. 9 (where N≤N* and M≤M*).

$$u ( N , M , n ) {=}^{def} ( α n - γ ) NM - β ( {N}^{*} {M}^{*} - NM ) - ω n N \qquad [ Equation 2 ]$$

For the description of parameters α, β, γ, and ω in Equation 2, reference may be made to FIG. 8.

When comparing Equation 2 with Equation 1, the first and third terms on the right-hand side have changed, and the first term of these terms reflects the fact that by performing the GEMV computation repeatedly n times using the same weight matrix, the computational efficiency of the PIM 122 may be increased without additional overhead for recording data to the PIM 122 (α→αn).

Furthermore, the third term of Equation 2 reflects the fact that the overhead O3 required for returning the result of computation processed in the PIM 122 to the computation device 121 may increase by a factor of n (ω→ωn).

Accordingly, for the case of FIG. 9, in operation S120, Equation 2 may be used to calculate the usefulness u(N, M) of offloading the first computation, but Equation 2 is merely one embodiment of the present disclosure and the present disclosure is not necessarily limited thereto.

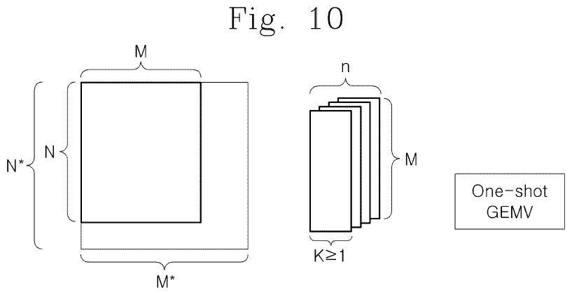

Furthermore, FIG. 10 generalizes the case of FIG. 9 and illustrates the case in which a GEMM computation is performed using a first matrix of size (N×M) and a second matrix of size (M×K) as operands (where N≤N* and M≤M*).

In this regard, Equation 3 below shows a mathematical expression for calculating the usefulness u(N, M) of offloading in the case of FIG. 10 (where N≤N* and M≤M*).

$$u ( N , M , K , n ) {=}^{def} ( {α}_{K} n - γ ) NM - β ( {N}^{*} {M}^{*} - NM ) - ω nNK \qquad [ Equation 3 ]$$

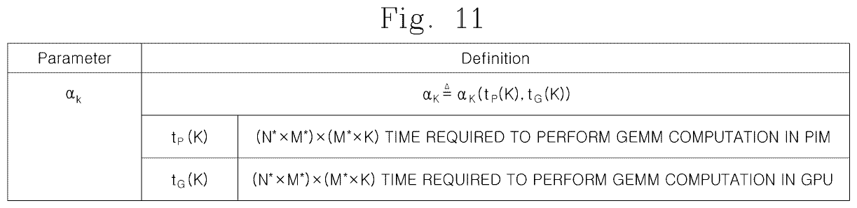

For the description of parameter α_{K} in Equation 3, reference may be made to FIG. 11, and for the description of the remaining parameters β, γ, and ω, reference may be made to FIG. 8.

Referring to FIG. 11, α_{K} is a parameter for the computational efficiency when offloading the first computation to the PIM 122 and processing the first computation, compared to when processing the first computation by using the GPU of the computation device 121, etc. α_{K} may be calculated based on: a computation time t_{P}(K) required when the first computation is offloaded to the PIM 122 and performed in consideration of the size of K; and a computation time t_{G}(K) required when the first computation is performed by the GPU of the computation device 121 without being offloaded.

When comparing Equation 3 with Equation 2, the first and third terms on the right-hand side have changed, and the first term of these terms reflects the computational efficiency of the PIM 122 based on the change of the GEMV computation to the GEMM computation (αn→α_{K}n).

Furthermore, the third term of Equation 3 reflects the fact that the overhead O3 required for returning the result of the computation processed in the PIM 122 to the computation device 121 may increase in proportion to the size of the output matrix, NK (ωnN→ωnNK).

Accordingly, for the case of FIG. 10, in operation S120, the usefulness (u(N, M)) of offloading the first computation may be calculated using Equation 3. However, Equation 3 is merely one embodiment of the present disclosure and the present disclosure is not necessarily limited thereto.

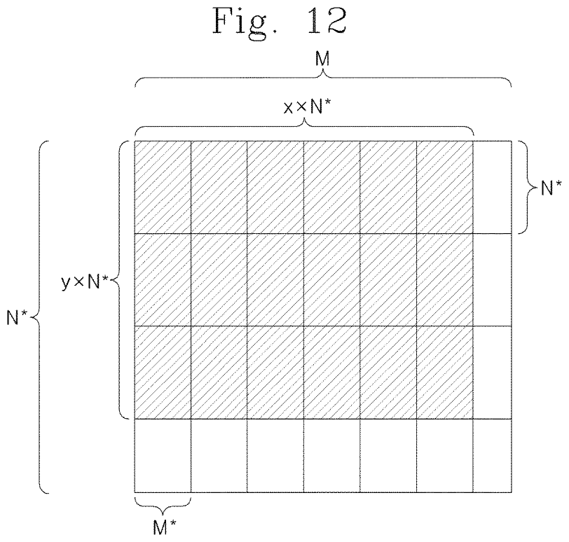

Furthermore, FIG. 12 illustrates the case in which the size (N×M) of a weight matrix in a GEMV or GEMM computation is larger than the optimal operand size (=N*×M*) of the PIM 122 (where N>N* or M>M*).

In this case, as illustrated in FIG. 12, in operation S120, the operands of the first computation, such as the weight matrix, may be divided into unit matrices having the optimal operand size (=N*×M*) to calculate the usefulness u(N, M) of offloading the first computation.

As a more specific example, in FIG. 12, it is possible to divide the operands of the first computation into x×y unit matrices having the optimal operand size (=N*×M*) (hatched areas in FIG. 12) and x+y+1 unit matrices smaller than the optimal operand size (=N*×M*) (unhatched areas in FIG. 12), and to sum the usefulness u(N, M) of offloading each unit matrix, thereby calculating the usefulness u(N, M) of offloading the first computation.

In this regard, Equation 4 below shows a mathematical expression for calculating the usefulness (u(N, M) of offloading in the case of FIG. 12 (where N>N* or M>M*).

$$u ( N , M ) = xy \times u ( {N}^{*} , {M}^{*} ) + x \times u ( ( N - y \times {N}^{*} ) , {M}^{*} ) + y \times u ( {N}^{*} , ( M - x \times {M}^{*} ) ) + u ( ( N - y \times {N}^{*} ) , ( M - x \times {M}^{*} ) ) \qquad [ Equation 4 ]$$

Accordingly, for the case of FIG. 12, in operation S120, the usefulness (u(N, M)) of offloading the first computation may be calculated using Equation 4. However, Equation 4 is merely one embodiment of the present disclosure and the present disclosure is not necessarily limited thereto.

Subsequently, in operation S130, offloading of the first computation may be performed based on the determination of the usefulness of offloading the first computation.

In operation S130, when the offloading benefit of offloading the first computation to the PIM 122 and processing the first computation is greater than the offloading overhead required for offloading the first computation to the PIM 122 and processing the first computation, that is, when the usefulness u(N, M) of offloading the first computation is greater than zero, the first computation may be offloaded to the PIM 122 and processed. However, the present disclosure is not necessarily limited thereto. Offloading may be performed in various ways, such as offloading the first computation to the PIM 122 and processing the first computation only when the usefulness (u(N, M) of offloading the first computation is greater than a predetermined threshold.

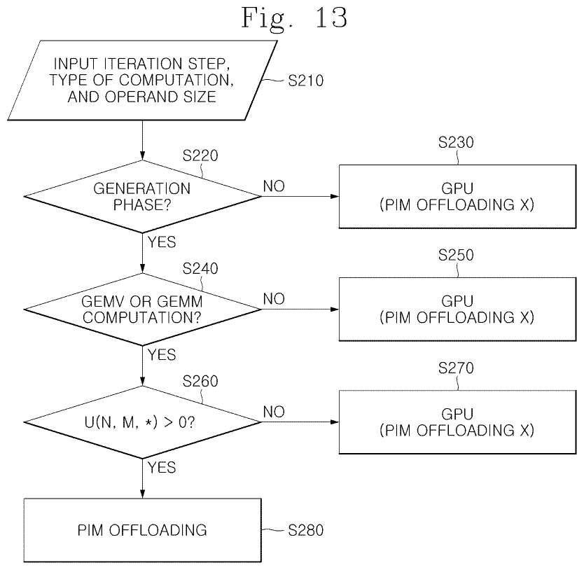

Furthermore, FIG. 13 illustrates a flowchart showing specific operations of the PIM offloading device 120 according to one embodiment of the present disclosure.

As illustrated in FIG. 13, with respect to a first computation to be offloaded to the PIM 122, the PIM offloading device 120 may receive an iteration step, the type of operator in the first computation, the size of an operand, etc. from a device that collects and holds information about the first computation (S210).

Accordingly, the PIM offloading device 120 may determine whether a step corresponding to the first computation corresponds to an initial phase in which an initial token for an input is generated or to a generation phase in which a subsequent token is generated (S220).

When the first computation corresponds to the initial phase, the first computation may be processed using the GPU of the computation device 121 without being offloaded to the PIM 122 (S230).

Furthermore, the PIM offloading device 120 may determine whether the type of operator in the first computation is a GEMV or GEMM computation (S240).

When the type of operator in the first computation does not correspond to the GEMV or GEMM computation, the first computation may be processed using the GPU of the computation device 121 without being offloaded to the PIM 122 (S250).

Then, the PIM offloading device 120 calculates the usefulness u(N, M) of offloading the first computation and compares the usefulness with a predetermined threshold (e.g., 0) to determine whether to offload the first computation to the PIM 122 (S260).

When the usefulness u(N, M) of offloading the first computation does not meet the threshold, the first computation may be performed using the GPU of the computation device 121 without being offloaded to the PIM 122 (S270).

On the other hand, when the usefulness u (N, M) of offloading the first computation meets the threshold, the first computation may be offloaded to the PIM 122 and performed (S280).

Furthermore, a computer program according to another aspect of the present disclosure is a computer program stored on a computer-readable medium in order to execute, on a computer, a series of operations of a method for performing PIM 122 offloading in the PIM offloading device 120, described above. The computer program may be a computer program containing machine language code made by a compiler as well as a computer program containing high-level language code that can be executed on a computer using an interpreter, etc. The computer is not limited to a personal computer (PC) or a notebook computer, but includes any information processing device that includes a central processing unit (CPU), such as a server, a smartphone, a tablet PC, a PDA, or a mobile phone, so as to execute a computer program.

Furthermore, the computer-readable medium may continuously store a computer-executable program, or temporarily store the computer-executable program for execution or downloading. Furthermore, the medium may be various recording means or storage means in which a single or multiple pieces of hardware are combined. The medium is not limited to a medium that is directly connected to a computer system, and may also be distributed on a network. Therefore, the detailed description should not be interpreted as restrictive in all respects, but should be considered to be illustrative. The scope of the present disclosure should be determined by a reasonable interpretation of the attached claims, and all changes within the equivalent scope of the present disclosure are included in the scope of the present disclosure.

Furthermore, the PIM offloading device 120 according to one embodiment of the present disclosure may be a device which performs processing-in-memory (PIM) offloading and includes: a processor; and a memory. The memory may include instructions configured to, when executed by the processor, cause the device to implement specific operations. The specific operations may include: collecting information about a first computation to be processed, the first computation including an operator and at least one operand; determining the usefulness of offloading the first computation, based on the information about the first computation and an optimal operand size of the processing-in-memory (PIM); and offloading the first computation, based on the determination.

The PIM offloading device 120 according to one embodiment of the present disclosure may be easily implemented based on the PIM offloading method described with reference to FIGS. 1 to 13. Hereinafter, the redundant description will be omitted and the main configuration of the present disclosure will be described.

In the determining operation, the usefulness of offloading the first computation may be determined based on the type of operator in the first computation, the size of the at least one operand in the first computation, and the optimal operand size of the processing-in-memory (PIM).

Furthermore, the specific operations may further include determining whether in an artificial intelligence model, the first computation corresponds to an initial phase, in which an initial token for an input is generated, or a generation phase, in which a subsequent token is generated, and determining not to offload the first computation when the first computation corresponds to the initial phase.

Furthermore, the specific operations may further include determining whether the type of the operator in the first computation corresponds to a GEMV or GEMM computation, and determining not to offloading the first computation when the first computation does not correspond to the GEMV or GEMM computation.

Furthermore, in the determining operation, the usefulness of offloading the first computation may be calculated based on: an offloading benefit of offloading the first computation to the processing-in-memory (PIM) and processing the first computation; and an offloading overhead required for offloading the first computation to the processing-in-memory (PIM) and processing the first computation.

The offloading benefit of the first computation may be calculated based on: a computation time required when the first computation is offloaded to the processing-in-memory (PIM) and processed; and a computation time required when the first computation is performed without being offloaded.

Furthermore, the offloading overhead of the first computation may be calculated based on: a resource required when the first computation is offloaded to the processing-in-memory (PIM) and processed in an all-bank mode; and a resource required when the first computation is performed without being offloaded.

Furthermore, the offloading overhead of the first computation may be calculated based on a resource required for converting the first computation to a data format of the processing-in-memory (PIM) in order to offload the first computation to the processing-in-memory (PIM).

Furthermore, the offloading overhead of the first computation may be calculated based on a resource required for returning the result of processing the first computation that has been offloaded to the processing-in-memory (PIM).

Furthermore, FIG. 14 illustrates a device 50 to which the proposed method of the present disclosure may be applied.

Referring to FIG. 14, the device 50 may be configured to implement a process in which PIM 122 offloading is performed by the PIM offloading device 120 according to the proposed method of the present disclosure.

For example, the device 50 to which the proposed methods of the present disclosure may be applied may include a network device such as a repeater, a hub, a bridge, a switch, a router, or a gateway, a computer device such as a desktop computer or a workstation, a mobile terminal such as a smartphone, a portable device such as a laptop computer, house electric appliances such as digital televisions, a movement means such as an automobile, and the like. In another example, the device 50 to which the present disclosure may be applied may be included as part of an application specific integrated circuit (ASIC) implemented in the form of a system on chip (SoC).

A memory 20 may be operatively connected to a processor 10, may store programs and/or instructions for processing and control performed by the processor 10, and may store data and information used in the present disclosure, control information required for processing the data and the information according to the present disclosure, temporary data generated during processing of the data and the information, and the like. The memory 20 may be implemented as a storage device such as read-only memory (ROM), random-access memory (RAM), erasable programmable read-only memory (EPROM), electrically erasable programmable read-only memory (EEPROM), flash memory, static RAM (SRAM), a hard disk drive (HDD), a solid-state drive (SSD), or the like.

The processor 10 may be operatively connected to the memory 20 and/or a network interface 30, and controls the operation of each module within the device 50. In particular, the processor 10 may perform various control functions for performing the proposed method of the present disclosure. The processor 10 may also be referred to as a controller, a microcontroller, a microprocessor, a microcomputer, etc. The proposed method of the present disclosure may be implemented using hardware, firmware, software, or a combination thereof. When the present disclosure is implemented using hardware, the processor 10 may include an application specific integrated circuit (ASIC), a digital signal processor (DSP), a digital signal processing device (DSPD), a programmable logic device (PLD), a field programmable gate array (FPGA), or the like configured to perform the present disclosure. Meanwhile, when the proposed method of the present disclosure is implemented using firmware or software, the firmware or the software may include instructions that are related to a module, a procedure, or a function for performing functions or operations necessary for implementing the proposed method of the present disclosure. The instructions may be stored in memory 20 or on a computer-readable recording medium (not shown) separate from the memory 20. The instructions may be configured to, when executed by processor 10, cause the device 50 to implement the proposed method of the present disclosure.

Furthermore, the device 50 may include the network interface device 30. The network interface device 30 may be operatively connected to the processor 10, and the processor 10 may control the network interface device 30 to transmit or receive wireless/wired signals carrying information and/or data, signals, messages, etc. over a wireless/wired network. The network interface device 30 supports various communication standards, such as IEEE 802 series, 3GPP LTE(-A), and 3GPP 5G, and may transmit and receive control information and/or data signals in accordance with the communication standards. The network interface device 30 may also be implemented outside the device 50 as needed.

Accordingly, in the method, the device, the system, and the computer program for processing-in-memory computation offloading for improving the inference performance of an artificial intelligence model according to one embodiment of the present disclosure, the inference performance of the artificial intelligence model may be improved based on the computational capability of the processing-in-memory (PIM) based on hardware in addition to the conventional software-based techniques for improving the inference performance of the artificial intelligence model. More specifically, the inference performance of an artificial intelligence model may be efficiently improved by determining the usefulness of processing-in-memory (PIM) offloading with respect to various types of computations performed in an artificial intelligence model.

The above embodiments and drawings described in the present specification are merely illustrative and are not intended to limit the scope of the present disclosure in any way. Furthermore, connection members or connections of lines between components illustrated in the drawings are merely illustrative of functional connections and/or physical or circuit connections, and may be represented by various alternative or additional functional, physical, or circuit connections in an actual device. Furthermore, unless specifically stated with the terms “essential,” or “important,” the components may not necessarily be required for the application of the present disclosure.

In the specification (particularly, in the claims) of the present disclosure, the use of the term “the” and similar indicative terms may refer to both singular and plural forms. Furthermore, when a range is stated in the present disclosure, this is intended to include inventions that apply individual values within the range (unless otherwise stated), and this is equivalent to stating each individual value constituting the range in the detailed description of the disclosure. Furthermore, the operations presented in the method invention of the present disclosure are not intended to be restrictive with respect to the order of execution of the operations, and the order may be appropriately changed as needed, unless the nature of each process requires that a specific operation necessarily precede another operation. In the present disclosure, the use of any examples or exemplary terms (e.g., etc.) is merely for the purpose of describing the present disclosure in detail, and unless limited by the claims, the scope of the present disclosure is not limited by such examples or exemplary terms. Furthermore, it will be understood by those skilled in the art that various modifications, combinations, and changes may be made based on design conditions and elements, within the appended claims or equivalents thereof.

What is claimed is:

1. A method for performing processing-in-memory (PIM) offloading by using a computing device, the method comprising:
collecting information about a first computation to be processed, the first computation comprising an operator and at least one operand;
determining usefulness of offloading the first computation, based on the information about the first computation and an optimal operand size of a processing-in-memory (PIM); and
offloading the first computation, based on the determination.

2. The method of claim 1, wherein in the determining, the usefulness of offloading the first computation is determined based on a type of operator in the first computation, a size of the at least one operand in the first computation, and the optimal operand size of the processing-in-memory (PIM).

3. The method of claim 1, further comprising determining whether in an artificial intelligence model, the first computation corresponds to an initial phase, in which an initial token for an input is generated, or a generation phase, in which a subsequent token is generated, and determining not to offload the first computation in case that the first computation corresponds to the initial phase.

4. The method of claim 1, further comprising determining whether the type of the operator in the first computation corresponds to a GEMV or GEMM computation, and determining not to offload the first computation in case that the type of the operator does not correspond to the GEMV or GEMM computation.

5. The method of claim 1, wherein in the determining, the usefulness of offloading the first computation is calculated based on:
an offloading benefit resulting from offloading the first computation to the processing-in-memory (PIM) and processing the first computation; and
an offloading overhead required for offloading the first computation to the processing-in-memory (PIM) and processing the first computation.

6. The method of claim 5, wherein the offloading benefit of the first computation is calculated based on:
a computation time required for offloading the first computation to the processing-in-memory (PIM) and performing the first computation; and
a computation time required for performing the first computation without offloading the first computation.

7. The method of claim 5, wherein the offloading overhead of the first computation is calculated based on:
a resource required for offloading the first computation to the processing-in-memory (PIM) and processing the first computation in an all-bank mode; and
a resource required for performing the first computation without offloading the first computation.

8. The method of claim 5, wherein the offloading overhead of the first computation is calculated based on a resource required for converting the first computation in accordance with a data format of the processing-in-memory (PIM) in order to offload the first computation to the processing-in-memory (PIM).

9. The method of claim 5, wherein the offloading overhead of the first computation is calculated based on a resource required for returning a result of processing the first computation that has been offloaded to the processing-in-memory (PIM).

10. A device for performing processing-in-memory (PIM) offloading, the device comprising:
a processor; and
a memory,
wherein the memory comprises instructions configured to, when executed by the processor, cause the device to implement specific operations, and
wherein the specific operations comprise:
collecting information about a first computation to be processed, the first computation comprising an operator and at least one operand;
determining usefulness of offloading the first computation, based on the information about the first computation and an optimal operand size of a processing-in-memory (PIM); and
offloading the first computation, based on the determination.

11. The device of claim 10, wherein in the determining, the usefulness of offloading the first computation is determined based on a type of operator in the first computation, a size of the at least one operand in the first computation, and the optimal operand size of the processing-in-memory (PIM).

12. The device of claim 10, wherein the specific operations further comprise determining whether in an artificial intelligence model, the first computation corresponds to an initial phase, in which an initial token for an input is generated, or a generation phase, in which a subsequent token is generated, and determining not to offload the first computation in case that the first computation corresponds to the initial phase.

13. The device of claim 10, wherein the specific operations further comprise determining whether the type of the operator in the first computation corresponds to a GEMV or GEMM computation, and determining not to offload the first computation in case that the type of the operator does not correspond to the GEMV or GEMM computation.

14. The device of claim 10, wherein in the determining, the usefulness of offloading the first computation is calculated based on:
an offloading benefit resulting from offloading the first computation to the processing-in-memory (PIM) and processing the first computation; and
an offloading overhead required for offloading the first computation to the processing-in-memory (PIM) and processing the first computation.

15. The device of claim 14, wherein the offloading benefit of the first computation is calculated based on:
a computation time required for offloading the first computation to the processing-in-memory (PIM) and performing the first computation; and
a computation time required for performing the first computation without offloading the first computation.

16. The device of claim 14, wherein the offloading overhead of the first computation is calculated based on:
a resource required for offloading the first computation to processing-in-memory (PIM) and processing the first computation in an all-bank mode; and
a resource required for performing the first computation without offloading the first computation.

17. The device of claim 14, wherein the offloading overhead of the first computation is calculated based on a resource required for converting the first computation in accordance with a data format of the processing-in-memory (PIM) in order to offload the first computation to the processing-in-memory (PIM).

18. The device of claim 14, wherein the offloading overhead of the first computation is calculated based on a resource required for returning a result of processing the first computation that has been offloaded to the processing-in-memory (PIM).

19. A computer-readable storage medium storing instructions configured to, when executed by a processor, cause a device, comprising the processor and configured to perform processing-in-memory (PIM) offloading, to implement specific operations,
wherein the specific operations comprise:
collecting information about a first computation to be processed, the first computation comprising an operator and at least one operand;
determining usefulness of offloading the first computation, based on the information about the first computation and an optimal operand size of a processing-in-memory (PIM); and
offloading the first computation, based on the determination.

20. The computer-readable storage medium of claim 19, wherein in the determining, the usefulness of offloading the first computation is determined based on a type of operator in the first computation, a size of the at least one operand in the first computation, and the optimal operand size of the processing-in-memory (PIM).
